(19) United States
(12) Patent Application Publication
(10) Pub. No.: US 2005/0153054 A1
(43) Pub. Date: Jul. 14, 2005

(54) Multicolored three-dimensional candy and method of manufacturing the multicolored three-dimensional candy

(76) Inventors: Cheng-Lung Huang, Taipei (TW); Cheng-Ching Huang, Pan Chiao City (TW); Chun-Hsien Wang, Shien Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/753,472

(22) Filed: Jan. 9, 2004

(51) Int. Cl. A23L 1/27

(52) U.S. Cl. 426/650

(57) ABSTRACT

A method for manufacturing a multicolored three-dimensional candy has the steps of heating materials, mixing pigment with the heated materials, injecting the mixed materials into a mold, adding a supplementary material to the mold, cooling to form a product and releasing the product from the mold. Since the materials are divided in parts into inject into different areas of the mold, the multicolored three-dimensional candy manufactured by the method has different areas with different depths, contours, shapes and colors. The appearance of the candy can attract customers to buy it.

### BACKGROUND OF THE INVENTION

1. Field of the Invention

The present invention relates to a multicolored three-dimensional candy, and more particularly to a multicolored three-dimensional candy that shows excellent three-dimensional relief and a method of manufacturing the multicolored three-dimensional candy.

2. Description of Related Art

With reference to FIG. 3, a conventional method of manufacturing three-dimensional (3-D) candy comprises the steps of heating materials (30), injecting the heated materials into a mold, cooling the material to form a product (31) and releasing the product from the mold (32). The first step is heating the raw materials of the candy to a liquid state. Additional pigment may be added to the raw materials. The second step is injecting the liquid raw materials to a mold that has a relief structure. The different colored liquid raw materials can be divided into parts to inject into the mold to show the different color gradation of the candy. The liquid raw materials are cooled to form a solidify product. The third step is separating the solid candy from the mold.

However, the color gradation of the candy just shows on the thickness direction and the 3-D structure of the candy only reflects the relief structure of the mold. The appearance of the candy manufactured by the conventional method cannot attract customers to buy the candy.

### SUMMARY OF THE INVENTION

The main objective of the present invention is to provide a multicolored three-dimensional candy that shows better three-dimensional features than conventional multicolored three-dimensional candy and a method of manufacturing the forgoing multicolored three-dimensional candy.

To achieve the objective, a method for manufacturing a multicolored three-dimensional candy has the steps of heating materials, mixing pigment with the heated materials, injecting the mixed materials into a mold, adding an supplementary material to the mold, cooling to form a product and releasing the product from the mold. Since the materials are injected separately into different areas of the mold, the multicolored three-dimensional candy manufactured by the method has different areas with different depth, curve and color. The appearance of the candy can attract customers to buy it.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of a method for manufacturing a multicolored three-dimensional candy in accordance with the present invention;

FIG. 2 is a perspective view of a multicolored three-dimensional candy in accordance with the present invention; and

FIG. 3 is block diagram of a conventional method of manufacturing a conventional multicolored three-dimensional candy in accordance with the prior art.

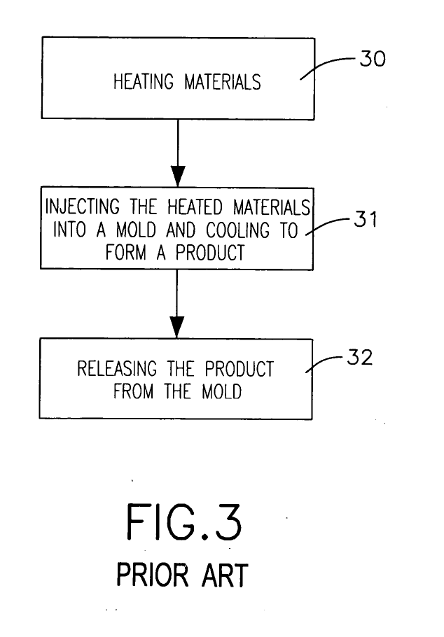

### DETAILED DESCRIPTION OF THE INVENTION

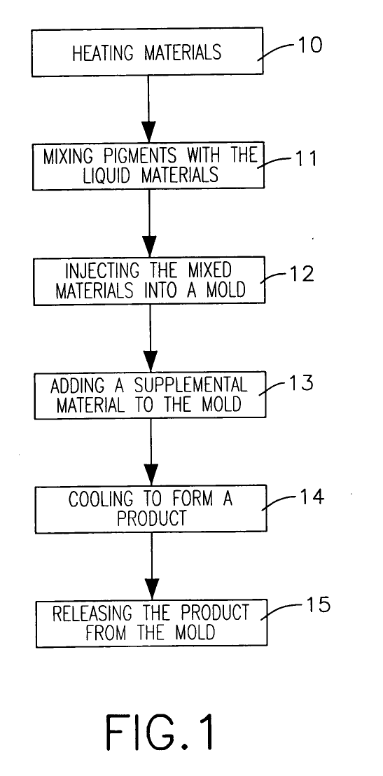

With reference to FIG. 1, a method for manufacturing a multicolored three-dimensional candy in accordance with the present invention comprises the steps of heating materials (10), mixing pigment with the heated materials (11), injecting the mixed materials into a mold (12), adding an supplementary material to the mold (13), cooling to form a product (14) and releasing the product from the mold (15).

The step of heating materials (10) comprises heating the individual raw materials until the individual raw materials become liquids.

The step of mixing pigments with the liquid materials (11) comprises mixing desired pigment with the individual liquid raw materials.

The step of injecting the mixed materials into a mold (12) uses an injector to inject a specific material into a desired part of the mold. The mold has different deep and shallow areas separated by division walls and may be pliable and manufactured of silicone. The injector has a nozzle and a compressor. The compressor has an air filtration apparatus. When a desired material is injected completely into one area of the mold and the materials solidify, an injector injects another desired material into another area.

The step of adding a supplementary material to the mold (13) comprises depositing supplementary material on the solidified materials to securely bond the solidified materials in the different areas.

The step of cooling to form a product (14) comprises controlling the raw materials and the supplementary material to a suitable temperature by carrying out the cooling step to form the product.

The step of releasing the product from the mold (15) comprises separating the product from the mold.

For example, manufacturing a candy from solid maltose and granulated sugar comprises the following steps.

Firstly in the step of heating materials (10), the maltose and granulated sugar are heated to a temperature of 140° C. to 150° C. to convert the solid maltose and granulated sugar to a liquid.

In the step of mixing pigment with the heated materials (11), desired color pigments are added to the liquid materials.

The step of injecting the mixed materials to a mold (12) requires putting the mixed materials into a single or multiple injectors and injecting the different colored materials into different areas of the mold.

The step of adding a supplementary material to the mold (13) is carried out after all the materials injected into the mold have solidified by depositing the supplementary material on the solidified materials to hold the solidified materials in adjacent areas.

The step of cooling to form a product (14) is performed by passing the product in the mold through a freezer tunnel that has three distinct temperature areas respectively at 3° C., 10° C. and 17° C. The different temperatures regulate the temperature of the product.

The step of releasing the product from the mold (15) comprises manually removing the pliable mold from the hard cooled product.

In the following example, manufacturing a multi-colored chocolate candy comprises the following steps.

In the step of heating materials (10), the chocolate is heated to a temperature of 45° C. to liquefy the chocolate. Then the liquid chocolate is decreased to a temperature of 38° C. in a mixer.

The step of mixing pigment with the heated materials (11) comprises adding a desired color pigment to the liquid chocolate.

In the step of injecting the mixed materials into a mold (12), the liquid, pigmented chocolate is put into an injector and injected into different areas of the mold.

The step of adding a supplementary material to the mold (13) step is carried out when all the pigmented materials have solidified by depositing supplementary liquid chocolate material on the solidified pigmented materials to hold the solidified materials in place. A temperature regulator is used to hold the chocolate in the molds at a specific temperature to enhance bonding between the materials. When the chocolate supplementary material is real chocolate, the temperature regulator maintains the temperature of the real chocolate at 28.5° C. When the chocolate supplementary material is compound chocolate, the temperature regulator maintains the temperature of the compound chocolate at 38° C.

The step of cooling to form a product (14) is carried out by passing the product in the mold through a freezer tunnel that has three temperature areas. For compound chocolate, the temperature areas are held respectively at 3° C., 10° C. and 17° C. For real chocolate, the temperature areas of the freezer tunnel are held respectively at 18° C., 10° C. and 13° C.

The step of releasing the product from the mold (15) comprises manually separating the pliable mold from the product.

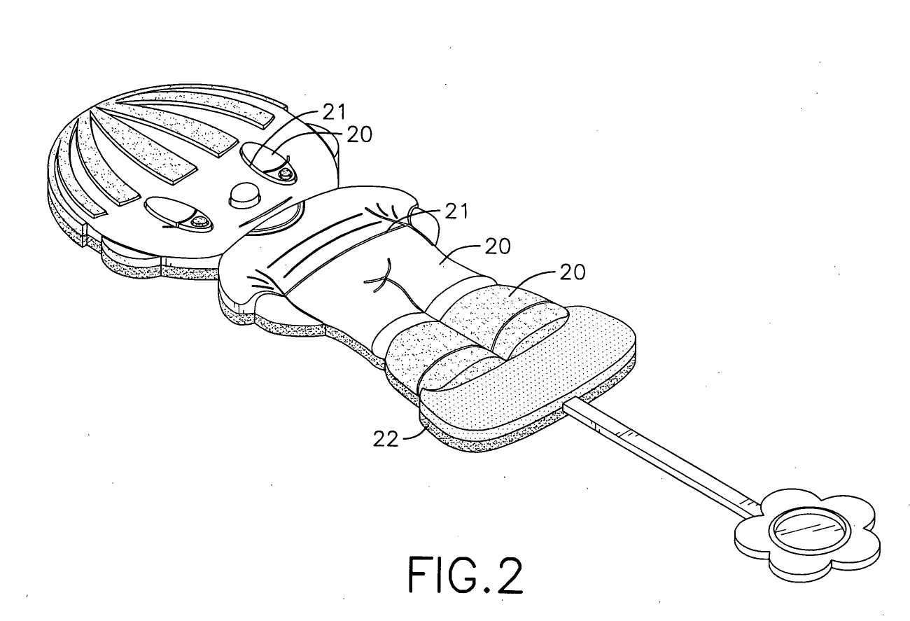

With further reference to FIG. 2, the multicolored three-dimensional candy manufactured by the method in accordance with the present invention has multiple areas with different colors, depths, shapes and contours. The product has an upper layer and a lower layer. Since the materials are divided into parts when injected into different areas of the mold, the upper layer has areas (20) with different depths, contours, shapes and color manufactured by the raw materials and the pigment. A gap (21) is formed between adjacent areas (20) by interior walls in the mold that define the different areas. The supplementary material forms a bottom layer on each candy and fills in the gaps (21) between adjacent areas. The 3-D structure of the multicolored three-dimensional candy in accordance with the present invention is better than that of the conventional candy.

Although the invention has been explained in relation to its preferred embodiment, many other possible modifications and variations can be made without departing from the spirit and scope of the invention as hereinafter claimed.

1. A method for manufacturing a multicolored three-dimensional candy comprising:
heating materials comprising heating individual raw materials until the individual raw materials become liquids;
mixing pigments with the liquid materials comprising mixing desired pigment with the individual liquid raw materials;
injecting the mixed materials into a mold comprising uses an injector to inject a specific material into a desired part of the mold and injecting other liquid materials into other areas after the injected materials solidify, wherein
the mold is pliable and has different deep and shallow areas separated by division walls and manufactured of plastic material; and
the injector has
a nozzle; and
a compressor having an air filtration apparatus;
adding a supplementary material to the mold comprising depositing supplementary material on the solidified materials to securely bond the solidified materials in the different areas;
cooling to form a product comprising controlling the raw materials and the supplementary material to a suitable temperature by carrying out the cooling step to formed the product; and
releasing the product from the mold comprising separating the product from the mold.

2. The method as claimed in claim 1, wherein the candy is manufactured from solid maltose and granulated sugar,
the step of heating materials heats the materials to a temperature of 140° C. to 150° C. to convert the solid maltose and granulated sugar to a liquid; and
the step of cooling to form a product passes the product in the mold through a freezer tunnel that has three distinct temperature areas respectively at 3° C., 10° C. and 17° C.

3. The method as claimed in claim 1, wherein the candy is manufactured from chocolate,
the step of heating materials heats the chocolate to a temperature of 45° C. to liquefy the chocolate and then the liquid material is decreased to a temperature of 38° C. in a mixer; and
the step of adding an supplementary material to the mold deposits supplementary chocolate material on the solidified materials to hold the solidified materials in adjacent areas and using a temperature regulator to hold the supplementary chocolate materials at a specific temperature to enhance bonding between the materials.

4. The method as claimed in claim 3, wherein the supplementary chocolate material is compound chocolate;
the temperature regulator maintains the compound chocolate to a temperature of 38° C.; and
the step of cooling to form a product uses a freezer tunnel that has three temperature areas respectively at 3° C., 10° C. and 17° C.

5. The method as claimed in claim 3, wherein the supplementary chocolate material is real chocolate;
the temperature regulator maintains the real chocolate to a temperature at 28.5° C.; and
the step of cooling to form a product uses a freezer tunnel that has three temperature areas respectively at 18° C., 10° C. and 13° C.

6. A multicolored three-dimensional candy comprising:
an upper layer having
areas with different depths, contours, shapes and colors manufactured by raw materials; and
multiple gaps respectively between adjacent areas; and
a lower layer bonded to the upper layer and manufactured from a supplementary material.
